(19) United States
(12) Patent Application Publication
(10) Pub. No.: US 2021/0291268 A1
(43) Pub. Date: Sep. 23, 2021

(54) METHOD FOR OBTAINING A BRASS BILLET WITH REDUCED LEAD CONTENT AND THE BILLET THUS OBTAINED

(71) Applicant: A.L.M.A.G. S.P.A. AZIENDA LAVORAZIONI METALLURGICHE ED AFFINI GNUTTI, Roncadelle (Brescia) (IT)

(72) Inventor: Gabriele GNUTTI, Roncadelle (Brescia) (IT)

(21) Appl. No.: 17/264,513

(22) PCT Filed: Aug. 5, 2019
(86) PCT No.: PCT/IB2019/056643

§ 371 Date: Jan. 29, 2021

(30) Foreign Application Priority Data
Aug. 10, 2018 (IT) 102018000008041

(51) Int. Cl. B22F 3/20; B22F 9/04; B22F 9/16; C22B 7/00

(52) U.S. Cl. CPC B22F 3/20; B22F 9/04; B22F 9/16; C22C 9/04; C22B 7/007; B22F 2998/10; C22B 7/001

(57) ABSTRACT

A method for obtaining a brass billet with reduced lead content involves machining a finished or semi-finished product made of traditional brass by chip removal to obtain traditional brass chips, performing a fragmentation treatment on the traditional brass chips to obtain traditional brass fragments, performing a lead removal treatment on the traditional brass fragments to obtain brass fragments with reduced lead content, melting in a furnace a charge comprising the brass fragments with reduced lead content, and obtaining a billet by direct or inverted extrusion of the molten product.

The subject of the present invention is a method for obtaining a brass billet and a brass billet thus obtained. In particular, the subject of the present invention is a brass billet with a reduced lead content.

By convention, brass is defined as “lead-free” if the lead content is less than 0.1% by weight; it is defined as “low lead content” if the lead content is between 0.1% and 0.2% by weight. Traditional brass, on the other hand, normally has a lead content varying between 1.5% and 3.5%.

As is well known, brass, an alloy of copper (Cu) and zinc (Zn), is a material widely used in the manufacturing industry, due, above all, to its excellent castability, which makes it possible to obtain semi-finished castings by means of melting processes, and to its excellent tool machinability, which makes it possible to finish the semi-finished product in a suitable manner by means of machining by chip removal.

The machinability of brass is highly dependent on the amount of lead (Pb) therein.

For some years now, however, there has been a need to manufacture certain products, such as taps or other components in contact with water, especially if potable, with lead-free alloys or alloys with a very low lead content. The main reason for this is the need to prevent lead from being dissolved in water, with consequences considered harmful to health.

The research and development efforts of many companies are therefore aimed at the definition of a lead-free brass which has mechanical characteristics and workability similar to those of traditional brass.

In this direction, one of the most promising approaches is the replacement of lead with graphite powder. In this regard, the Applicant is the holder of the Italian patent application for invention No. 10 2013 9021 8136 5.

Further research efforts are focused on how to obtain lead-free brass fragments to be mixed with graphite powder. In this context, the Applicant is the holder of the International Application WO-A1-2017/199147, which illustrates the obtaining of lead-free brass fragments from lead-free brass chips from mechanical machining by chip removal to which lead-free brass products are subjected.

The present invention concerns on the other hand an innovative method for obtaining brass billets with a reduced lead content compared to the usual one, and the billet thus obtained. According to the invention, traditional brass chips (i.e. with normal lead content) are chemically and mechanically treated to lower their lead content.

The characteristics and advantages of the method according to the present invention will be apparent from the description provided hereinafter.

According to the invention, a method for obtaining brass billets with reduced lead content provides for a step of obtaining traditional brass chips.

Said traditional brass chips are the result of mechanical machining by chip removal performed on semi-finished or finished products made of traditional brass.

According to the type of traditional brass of which the finished or semi-finished product is composed and according to the type of mechanical processing from which it derives, the chip takes on the characteristic curled shape or a more shredded appearance.

The method further provides for subjecting traditional brass chips, after washing to remove dirt and pollutants such as cooling fluids and/or lubricants if necessary, to a mechanical fragmentation treatment, aimed at increasing the ratio between the total surface area of the chips and the overall volume occupied. From the fragmentation treatment, traditional brass fragments are obtained.

Preferably, said mechanical fragmentation treatment consists of a grinding of the traditional chips.

Subsequently, the traditional chip fragments are subjected to a chemical treatment to reduce the lead content.

Said chemical treatment consists of a lead removal performed by immersing the fragments of traditional brass in a bath with a solution of water and one or more organic acids.

For example, said organic acids are selected from the group comprising butyric acid, propionic acid, 2-propenoic acid, acrylic acid.

Preferably, the lead removal bath is agitated, e.g. by ultrasound or mechanically.

The lead removal treatment produces brass fragments with a reduced lead content.

According to a preferred execution of the method, if the brass fragments subjected to the lead removal bath do not have a sufficiently low lead content, the fragmentation treatment and lead removal treatment are performed again, recursively.

According to one variant execution of the method, the lead removal treatment is performed on traditional, non-fragmented brass chips, and the subsequent fragmentation treatment (and further lead removal) is performed if the lead content of the chips subjected to the previous lead removal is not sufficiently low.

Preferably, the fragments are subjected to a pressing before a further fragmentation treatment is carried out. Advantageously, this allows the external surface of the fragments, on which the lead removal treatment mainly acts, to be increased.

According to a further variant execution of the method, several fragmentation treatments and subsequent pressings are carried out recursively, before a lead removal treatment is carried out.

The brass fragments with reduced lead content finally obtained are used as charge for a melting furnace, preferably together with substantially pure copper and zinc (e.g. copper foil and zinc cakes) and/or further brass scrap, to obtain a melting bath having a desired metallurgical composition.

The molten metal is used to obtain a billet by means of direct or inverted extrusion.

The billet obtained according to the method described above is then used to obtain a bar having the desired diameter and length.

The bar is then subjected by the user to mechanical machining by chip removal and the brass chips thus obtained are then again subjected to the method according to the invention. In this way, by working recursively, the brass will progressively assume an increasingly lower lead content.

Innovatively, the method according to the present invention is extremely advantageous from an industrial point of view, as it allows the use of traditional brass chips, i.e. with a normal lead content, to obtain brass billets with a reduced lead content.

In addition, advantageously, the use of chips allows machining by chip removal in a remote plant, usually by the user of the bar, in order to produce a semi-finished or finished product, and the fragmentation of the chips and the lead removal bath in a main plant. The chips are transported from the remote plant to the main plant.

Otherwise, advantageously, the machining step for chip removal is performed in a first remote plant, usually by the user of the bar, in order to produce a semi-finished or finished product, the traditional brass chips are transported to a second remote plant, the fragmentation and lead removal treatments are performed in said second remote plant. Finally, the brass fragments with reduced lead content are transported to a main plant where they are melted, and the new billet is created.

1-7. (canceled)

8. A method for obtaining a brass billet with a lead content reduced to less than 1.5% by weight, the method comprising:
performing mechanical machining by chip removal on a finished or semi-finished product of traditional brass to obtain traditional brass chips;
performing on said traditional brass chips a fragmentation treatment to obtain traditional brass fragments;
performing on said traditional brass fragments a lead removal treatment to obtain brass fragments with reduced lead content, wherein the lead removal treatment consists of lead removal bathing in a solution of water and one or more organic acids;
melting, in a furnace, a charge comprising said brass fragments with reduced lead content; and
obtaining a billet by direct or inverted extrusion of a cast of a molten product,
wherein, if the lead content of the brass fragments with reduced lead content is not low enough, a further fragmentation treatment and a further lead removal treatment are performed and, prior to the further fragmentation treatment, the brass fragments with reduced lead content to be subjected to the further fragmentation treatment are pressed.

9. The method of claim 8, wherein the lead removal bathing is agitated.

10. The method of claim 9, wherein the lead removal bathing is agitated by ultrasound.

11. The method of claim 8, wherein the fragmentation treatment consists of grinding.

12. The method of claim 8, wherein the one or more organic acids are selected from the group consisting of butyric acid, propionic acid, 2-propenoic acid, and acrylic acid.
